(19) United States
(12) Patent Application Publication
(10) Pub. No.: US 2002/0116235 A1
(43) Pub. Date: Aug. 22, 2002

(54) Reservation system and methods for theme parks

(75) Inventors: David C. Grimm, Winter Garden, FL (US); James D. Waters, Orlando, FL (US); Mark A. Woodbury, Orlando, FL (US); Matthew Preston Jones, Honolulu, HI (US)

Correspondence Address: LYON & LYON LLP, 633 WEST FIFTH STREET, SUITE 4700, LOS ANGELES, CA, 90071, US

(73) Assignee: Universal City Studios, Inc.

(21) Appl. No.: 10/071,633

(22) Filed: Feb. 7, 2002

Related U.S. Application Data
(60) Provisional application No. 60/267,126, filed on Feb. 7, 2001.

(51) Int. Cl. G06F 17/60

(52) U.S. Cl. 705/5

(57) ABSTRACT

In a system for managing admissions into parks and attractions, a guest requests reservations via a kiosk unit or purchases advanced ticket attraction packages via the World Wide Web/Internet or through the phone. Once the reservations or purchase has been made, the confirmed reservation is printed onto a confirmation ticket or guest card and the data is uploaded into the system. The guest can then take their confirmation ticket or guest card at the appointed time and gain entry into the attraction through a barrier controlled by the controller unit. The controller unit reads or scans the guest card and allows guests with advance reservations to gain entry without waiting in long lines. In an alternative park operation system, admission to the park is permitted only with advance reservations. As part of the advance reservation, each guest is assigned to a menu group, with each menu group provided with assigned times for each attraction in the park. The number of advance reservations is limited so as not to exceed attraction capacities. This largely avoids having guests wait extensively to attend an attraction.

### RELATED APPLICATION

This Application claims priority under 35 USC §120 to U.S. patent application Ser. No. 60/267,126, filed Feb. 7, 2001, and now pending and incorporated herein by reference.

### BACKGROUND OF THE INVENTION

1. Field of the Invention

This invention relates to systems and apparatus for managing sales of tickets and admissions to theme parks and attractions.

2. Background

A common disadvantage at most parks (including theme and amusement parks) is the long lines starting with getting into the parking lot, getting into the park, waiting for lunch or dinner, and of course at the attractions themselves. Various techniques have been tried to find ways to avoid long lines or to find ways of shortening or eliminating the waiting period associated with lines. For example, supermarkets have designated express checkout lanes; banks offer merchant teller lines, to offer merchant customers faster or specialized service and shorter lines; and even parking garages have express lanes to offer monthly card holders faster exit routes.

In a park, the difficulties associated with long lines are even more pronounced. The entry costs or ticket prices may be significant. Consequently, many guests in parks want and expect to be able to experience many attractions in a single day. Time spent waiting in line detracts from the overall park experience. Although attractions are the main reason guests come to a park, many parks now offer much more. For example, most theme parks, have a variety of shops, restaurants, live entertainment, music, parades, etc., that guests can enjoy simply by walking through the park. All of these secondary offerings generally cannot be enjoyed while the guest is waiting in line.

Having guests waiting in line is also disadvantageous for the park owner. Guests are less satisfied with their park experience when that experience includes extensive waiting in line. In addition, guests cannot attend other areas, shops, restaurants, etc. For example, while waiting in line, guests cannot browse through stores and make purchases, eat at restaurants within the park, or play games at the arcade or gaming booths.

Many attempts have been made to reduce waiting in line at parks. For example, U.S. Pat. No. 5,987,420 issued to Maeda describes a reservation system that allows patrons or guests to obtain reservations for various rides ahead of time. However, patrons can make an unlimited number of reservations. This can result in earlier patrons reserving all ride time slots leaving only less popular rides for late arriving patrons.

The Maeda patent also does not provide a method of rescheduling a reservation to obtain the optimal schedule. If a patron has current reservations but wishes to make additional reservations, the Maeda et al. system does not check to reschedule the entire schedule to put forth the most optimal schedule. This means that, if the patron has a 12:00 PM reservation for Attraction 1, and there are other available times, but the only available time for Attraction 2 is 12:00 PM, the patron can only be told that there are no available reservation time slots open for Attraction 2.

In the Maeda et al. patent, cancellations are filled by patrons waiting at the gate for cancellations. However, if there are no cancellations while the patron is waiting, then the waiting patrons may not get to see or ride the attraction but would have had to come to the attraction and wait by the display monitor.

U.S. Pat. No. 6,173,209 issued to Laval describes a reservation and line management system where patrons are allowed to make reservations for only one attraction at a time. By allowing only one reservation at a time, patrons are unable to schedule their entire day, including time taken for lunch and dinner. Many times, groups will split up and rejoin at a later time during the day. In the Laval patent, patrons can only make schedules one or two hours ahead, because they are limited to one reservation. Moreover, if the only available reservation for a desired attraction is late in the day, the usefulness of this system declines, as the patron may be limited in the number of reservations the patron can make throughout the day.

Accordingly, there is a need for a method and system that better manages sales, reservations, information, and wait times at amusement and theme parks. This system and method addresses those needs. The invention resides as well in sub-combinations of the present system and methods.

### SUMMARY OF THE INVENTION

A system and separate method of operation allow guests to purchase advance ticket packages containing e.g., pre-paid parking, reserved times for multiple attractions, reservations for meals, or use of a guest key as a credit or debit card. In addition, the system and separate method of operation allow guests to make reservations for reserved access to attractions, such as rides, live action-shows, etc. or for dining or theatrical shows, etc., all such activities are collectively referred to here as attractions.

In another aspect of the invention, the system preferably has several kiosks located throughout the theme park. Each kiosk advantageously contains one or more guest touch screen terminal/readers or other input, display, or output device allowing interface between the guest and the system (with all such devices and their equivalents collectively referred to here for purposes of explanation as a terminal or a touch screen terminal). The touch screen terminal also has or is connected to a ticket reader or scanner, a card dispenser, and a system for accepting money (cash or credit). The touch screen terminal may optionally be replaced with another guest interface device, such as a computer or internet appliance, either in the park, or elsewhere.

Pre-sale attraction packages and reservations are preferably controlled by a computer program or control file. This file contains parameters that allow the system flexibility in assigning reservations, based on the class of ticket, and/or other parameters. Pre-sale attraction packages and reservations may be allowed ranging from one attraction at a time, to several.

The system may be run with a processor, memory for storing data and program code, connection to a network, by presenting data according to the program code, and by receiving signals and selections from a terminal, as is well known in the art. The terminal may include any type of computing device that can connect to a network, receive and display information from a central computer, and transmit signals and selections back to the central computer. The terminal preferably has computer processing capability (e.g., a CPU) to manage its functions. A microprocessor based file server could be used to manage the system (i.e. Windows 2000 server or a Sun computer).

The program code to operate the system is stored in computer readable media. Any currently existing or future developed computer readable medium suitable for storing data can be used to store the program code and associated data, including, but not limited to, hard drives, floppy disks, digital tape, flash cards, compact discs, and DVDs. The computer readable medium may include more than one device, such as two linked hard drives. Moreover, any server system that can exchange data with a user may be used. The exchange of data can include, for example, the World Wide Web/Internet or direct user connections to the system through a plurality of network options.

Each touch screen terminal preferably has the ability to display the current times that reservations are available for a particular attraction, upon the guest selecting the attraction as one for which the guest desires a reservation. Reservation times may be adjusted automatically by the system. In addition, any reservation card that is printed out advantageously indicates the reserved time(s), and also the date(s) on which the reservation(s) are valid.

The touch screen terminal is preferably able to verify the validity of the guest by reading their guest key which can be an admission ticket, identification card, or some other means of identifications (with all such devices and their equivalents collectively referred to here for purposes of explanation as a identification card). The guest is then verified to ensure that they are a valid guest, e.g., that the admission ticket is valid for the day on which it is being used.

The touch screen terminal is preferably further able to receive cash or credit purchases for pre-sale attraction packages as well as dispense a ticket such as a card with a magnetic stripe, embedded microchip, receipt with a bar code, or any other of a number of emerging technologies for storage and retrieval of data in easily carried packages, including a variety of contact, and non contact manifestations thereof.

In operation, the guest may purchase pre-determined attraction packages of, for example, 5 to 15 rides and attractions. In addition to reserved rides and attractions times, each package may also include pre-paid parking, reservations for meals, and monetary value put into each identification card. This allows the guest to use the guest key as a credit card reducing the need to carry cash.

The credit feature of the identification card is especially advantageous for children who have a tendency to lose cash. If the card is lost or stolen, it may simply be deactivated and a new one issued to the guest. The card also allows parents to help control the spending of their children.

An individualized package may optionally allow the guest to choose every attraction in the pre-sale attraction package, rather than having pre-determined packages to choose from.

These attraction packages may be purchased on-line prior to guest arrival to the park or upon guest arrival at the ticketing booth or at one of the kiosks located at the park.

Guests may choose to only participate in the pre-sale attraction package thereby avoiding waiting in lines. Alternatively guests may purchase a smaller pre-determined attraction package in advance, leaving room to participate in making further reservations after their arrival at the park.

In an alternative embodiment, every attraction or group of attractions is accessible only through advance reservations. An entire park is designed around pre-set guest schedules so there is little waiting for any of the rides or attractions. The park may have a set of attractions, for example ten (10) attractions and the guests may be then divided into groups. Each group being assigned a time for the various attractions in the package (packages may contain a few to all the attractions in the park). Each guest of each group is assigned a reservation time for each attraction so there is little wait time for any of the attractions. The groups rotate from attraction to attraction largely eliminating all wait times for the attractions. Even meal times may be staggered to limit waiting. In this type of park, ticket sales for any given day are limited to a maximum number, so that the scheduled reservation times do not exceed the capacity of the attractions. In this reservations only type of park, tickets are processed in menu groups of e.g., 100-5000, 500-3000 or 1000-2000 guests. A menu group of, for example, 1800 guests is pre-subdivided into time slot groups of 450 guests each. The guests in the time slot groups of 450 guests, in this example, have a predetermined time interval, of e.g., 5-30 minutes in which they can view an attraction. The time slot groups may be rotated with a one-hour time block to avoid having guests travel through the park all day with the same group of 450 people. The tickets are preferably sold with predetermined show or attraction times printed on them. These show times are paced out over the day so that the guests can easily attend all attractions without rushing. Since there is virtually no waiting for any attractions, guests have additional time for eating, shopping, and other activities.

Alternatively and in conjunction with the pre-determined attraction package, the guest may also choose to make reservations for attractions and meals upon their arrival at the park. In order to participate in the reservation program, guests may be required to purchase a reservation card (i.e. identification card) or alternatively they may be given out freely. The guest inserts or presents the identification card for reading by the card reader or scanner, which is preferably in or at a kiosk. The card is read via a magnetic stripe, microchip, bar code, or similar media on the identification card. The system matches the card as read to a database and determines the class or type of ticket read. The system then preferably provides the guest with options for the guest to select attraction reservation times, with the options depending on the class of the ticket.

Reservations may optionally be limited by certain pre-determined parameters. For example, the attractions may be categorized by various criteria (i.e. geography, popularity, etc). The guest will then be allowed to choose a limited number of attractions in each of the defined categories.

The system optionally determines two available reservation times for an attraction selected by the guest. The two available reservation times are displayed to the guest. The guest selects one of the two times displayed. If the guest makes reservations for more than one attraction, the system may account for walking and/or other time between attractions, in determining the two available reservation times displayed to the guest, for each attraction. A document may optionally be printed, for the attraction selected, displaying the attraction(s) and the time(s) of the reservation.

Optionally, if, by virtue of the guest's ticket type or some other criteria, the guest is entitled to receive reservations for more than one attraction, the system may be configured to offer to the guest two different sets of reserved time slots for the attractions selected by the guest, instead of the guest separately selecting from among two time slots offered to the guest for each such attraction selected by the guest. Optionally, attractions will be categorized by popularity, proximity, or some other criteria. Guests may have the ability to choose one or any number of attractions from each category. Categorizing and limiting the numbers by category will allow a more equitable distribution by the criterion set by the park.

If the ticket read was part of a transaction involving more than one guest, the system may be designed to ask if all members of the party want the same reservation time(s), or to separately handle reservations for individual members of the group.

The system preferably initially determines whether the guest currently has any active reservation on any attraction, and may limit making any further or conflicting reservations. The terminal within or at a kiosk may also be limited to making reservations only for nearby attractions, or attractions within a zone or area served by that kiosk. Alternatively, the system may permit reservations for any attraction to be made at any kiosk. The system may be configured to allow reservations for more than one attraction to be made at any given kiosk. In this type of system, some or all of the attractions may optionally be grouped, to ensure that a guest's schedule includes more popular attractions as well as less popular attractions, to increase use of reservations at the less popular attractions.

After a guest obtains a reservation, either purchased in advance or made earlier at the park, to enter an attraction during a particular time slot, and the guest returns to the attraction during the time slot, an attendant at the attraction may manually verify that the guest is entitled to enter a queue for the attraction, separate from the queue in which guests without reservations for the attraction are waiting to enter the attraction. Such verification may be made by the attendant examining a reservation ticket (or a display on an electronic device, such as a cell phone or other cellular device) presented by the guest, or by other manual means by the attendant. This verification is not made automatically by the guest inserting, swiping or feeding an encoded card or other object into a computerized or automated scanning or reading device, or otherwise by the guest causing a computerized or automated device to verify that the guest possesses a reservation entitling the guest to enter the separate queue, if such computerized or automated device is connected to the central computerized reservations system.

The system software preferably prevents guests from making reservations and going back to the same attraction more than once, twice, or multiple times, by requiring a pre-selected amount of time between reservations at the same attraction, or by counting and then limiting the number of reservations made for an attraction by a guest, over a selected time interval, such as a day, two or three days, or over several days.

In another alternative system design, an employee will scan a card with a special barcode that allows them access to issue return times for any time or attraction for guest recovery purposes. The system may also associate the number of tickets purchased in a transaction to allow the park operator to issue reservations per group. An attraction dashboard feature may be provided to allow an employee to view a matrix of all attractions and their remaining capacity by time slot. Security and data purging functions may also be included.

By making reservations or purchasing attraction packages using the system described, guests at an amusement or theme park can reduce time spent waiting in line.

In another embodiment, the system preferably includes a kiosk unit, a maintenance unit, and a controller unit which work in unison to improve the way a guest spends time in a park.

The kiosk unit is advantageously accessed through the guests' admission ticket or identification card or an equivalent guest identifier, such as a number, password, voice print, fingerprint scan, etc. The ticket or card, number, etc. may be received upon entrance to the park and may include a bar code for identification purposes. Once activated, the kiosk unit can be accessed through the use of the touch screen terminal.

The guest may obtain a variety of information from the kiosk units including requests for reservation times. Once the reservation times for the attractions have been requested, the maintenance unit advantageously calculates the optimal schedule based on the reservation requests. The guest preferably obtains a schedule for the day that includes their requested attractions at the closest available times. After receiving the reservation, the kiosk unit may also print the confirmed schedule.

The guest can then proceed to the reserved attraction. Each attraction is preferably serviced by two lines, a reservation queue and a non-reservation queue. Guests with reservations or pre-purchased attraction packages can simply proceed through the reservation queue after arriving at the designated time. A scanner or other identifier device or person, preferably located at the start of the reservation queue, reads the identification card, bar coded reservation slip, or otherwise identifies the guests and grants entry. Once in the reservation queue, the guest is admitted into the attraction within a shortened time period. The non-reservation queue is for guests who have not made reservations. These guests wait in line.

Alternatively, the system preferably includes a reservation application software that may be remotely accessed by the guest. Access may be made through but is not limited to the internet, through cable lines, or through the phone. The software enables guests to obtain a variety of information on the park, attractions, wait times, reservation status, etc. Additionally, the application further enables the guest to obtain and/or purchase reservations for attractions in advance. The reservations may be from one attraction to as many as will fit into the guest's schedule.

In general, at least some attractions will have guests in line with and without reservations. This allows guest to have the choice and freedom to make reservations for some attractions ahead of time, while attending other attractions without reservation times between their reservations. This ratio can be altered as necessary by the maintenance unit monitoring the queues continuously so that reservation times can almost always be satisfied without the need for any changes. Preferably, 10-100% of the guests at an attraction included in the reservation system will have reservations, and will be directed to and admitted into the attraction from a reservation line, having a relatively short wait time, e.g. about 5-20 minutes. The balance of the guests are admitted from a non-reservation line, which will have longer wait times. The reservation system accounts for the capacity of the attraction (e.g. guests per hour); attraction cycle times, or start/end times, intermittent or random events affecting attraction operations (e.g. weather, mechanical failures, etc.). Consequently, guests with reservations can be admitted to an attraction at or close to their reservation time.

### BRIEF DESCRIPTION OF THE DRAWINGS

FIG. 1 is a block diagram of the primary system.

FIG. 2A is a schematic diagram of an attraction management system for a particular attraction.

FIG. 2B is a schematic diagram of an attraction management system without a non-reservation queue.

FIG. 2C gives an overview of the attraction management system without a non-reservation queue.

FIG. 2D gives a sample itinerary for the entire day.

FIG. 3A shows an identification card which may be given to guest when they buy their tickets.

FIG. 3B shows a ticket stub which can be used throughout the park for guest identification.

FIG. 4A is a front view of a kiosk unit.

FIG. 4B is sample screen that appears on the touch screen monitor of the kiosk unit.

FIG. 4C is a sample confirmation ticket obtained by patrons after making a reservation.

FIG. 5 is a flow chart diagram showing the variables used in calculating reservation capacity for a particular attraction.

FIG. 6 is a sample table used to show a hypothetical selection of attractions and final reservation offered.

FIG. 7 is a sample display of the status of attractions given to guests upon their inquiry for a reservation.

FIG. 8 is table illustrating the dynamic rescheduling that the system produces upon new reservation requests.

FIG. 9 is a schematic diagram of a line for guests with reservations and all the components used in managing the line.

### DETAILED DESCRIPTION OF THE DRAWINGS

The following description is provided in reference to a park containing multiple attractions. The present system and methods may also be applied in any other setting where advanced scheduling or reservations can be utilized to optimize a guest or participant's time while at a particular location or function (e.g. trade shows, training programs, expositions, fairs, theatres, etc.).

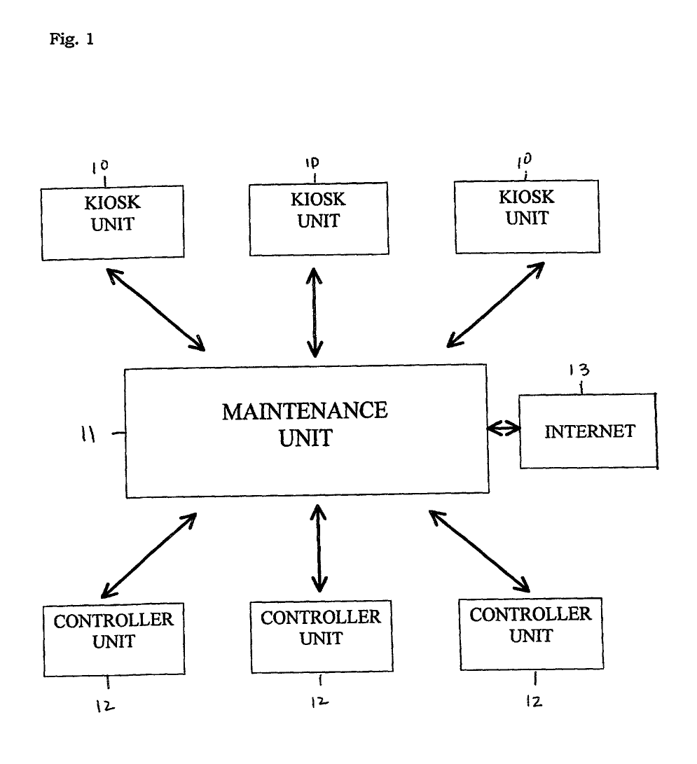

Referring to FIG. 1, a guest accesses one of the various kiosk units 10. The kiosk unit 10 then communicates with the maintenance unit 11 to obtain the identity of the guest. Once identification is established, the maintenance unit 11 supplies the kiosk unit 10 with up to the minute data on the various attractions. The guest inputs their reservation request for various times and attractions. The guest may be allowed to pick specific times for specific attractions, be given a choice of attractions for various times, choose attractions and be given choice of times, be allowed to choose any combination of attractions, be given predetermined packages, be allowed to choose a limited number of attractions from particular categories of attractions, or any combination thereof. Once the reservations are made at the kiosk unit 10, the data is transmitted to the maintenance unit 11. Once the reservations have been input into the kiosk unit 10 by the guest, that information is transmitted back to the maintenance unit 11 so the system may be updated. The maintenance unit 11 then transmits the reservation data to the controller units 12 to enable the controller units 12 to recognize valid reservation holders. This can be done when the guest tries to access the attraction or it can be done prior to the guest's arrival. The reservation data is preferably stored in the maintenance unit 11. However, a small portion to all the reservation data may also be stored at any other location, including the kiosk unit 10 or the controller unit 12.

Alternatively, guests may obtain information and purchase pre-determined attraction packages on-line through the World Wide Web/Internet 13. The guest's computer communicates with the maintenance unit 11 to obtain up to the minute information on availability of attraction packages. The guest may then purchase attraction packages consisting of reservations times for attractions, a parking pass, meal reservations, and monetary units to be credited to some type of guest identifier. The means of identification will preferably take the form of a card but may be through any appropriate device such as a cell phone, pda, pager, face recognition software, or other database used to identify individuals. Once the purchase is confirmed, the data is stored in the maintenance unit 11 and passed onto the controller unit 12 so that the controller unit 12 can allow the guest to enter the queue at the appropriate time. The data may be stored at the maintenance unit 11 and accessed by the controller unit 12 at the appropriate time or portions may be stored at the controller unit 12 in advance.

In one embodiment of the present invention, access to the kiosk unit 10 is limited to valid ticket holders. Once accessed, the kiosk unit 10 can provide a wealth of information to the guest from such things as maps, the current weather outlook, attraction wait times including a list of the attractions with the shortest or longest wait times, suggestions on things to do, places to see, or places to eat and shop, etc. In addition, the information provided by the system may be tailored to the individual guest. For example, if the guest's party contains small children, it may provide information regarding rides with height requirements or provide advertisements and information relevant to small children (ads for areas such as jungle gym or children's area). Moreover, the system may provide tailored advertisements based upon the guest's personal habits (types of rides they choose, types of restaurants they eat at, etc). This data may be collected through optional surveys or by analyzing the guest's buying habits and choice of attractions which are stored by the system. All information that is viewed can also be printed so the guest can retain a copy.

Once a guest has requested a reservation for a certain attraction, the kiosk unit 10 transmits the request to the maintenance unit 11 to be evaluated for availability. If the maintenance unit 11 determines that the requested time is available, it transmits the availability to the kiosk unit 10. The guest then has the option of accepting or declining the reservation. If the guest chooses to accept the reservation, this information is transmitted to the maintenance unit 11 so the information may be updated. The reservation is then passed onto the controller unit 12 so that the controller unit 12 can allow the guest to enter the attraction queue at the appropriate time.

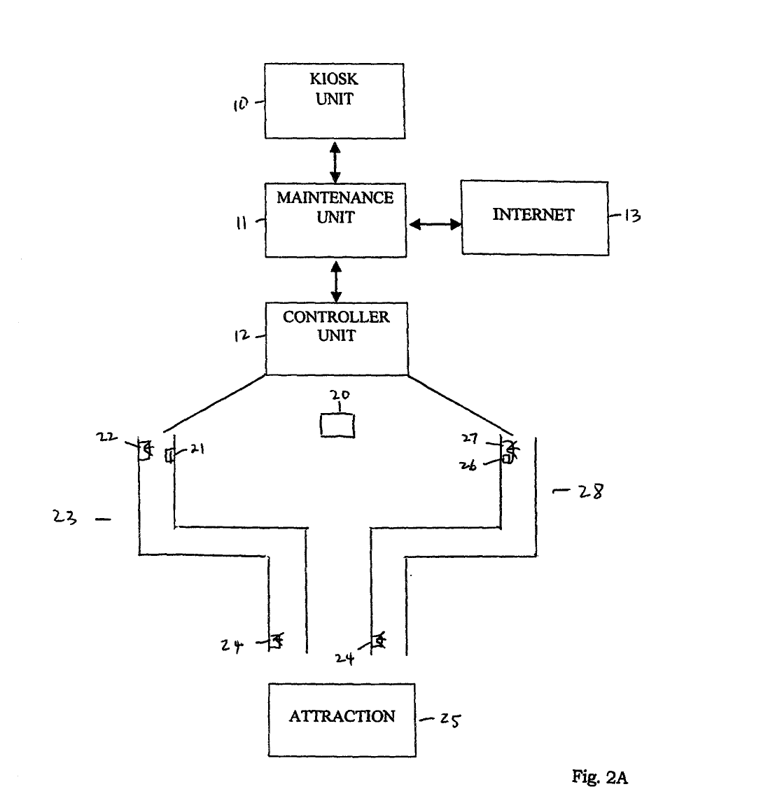

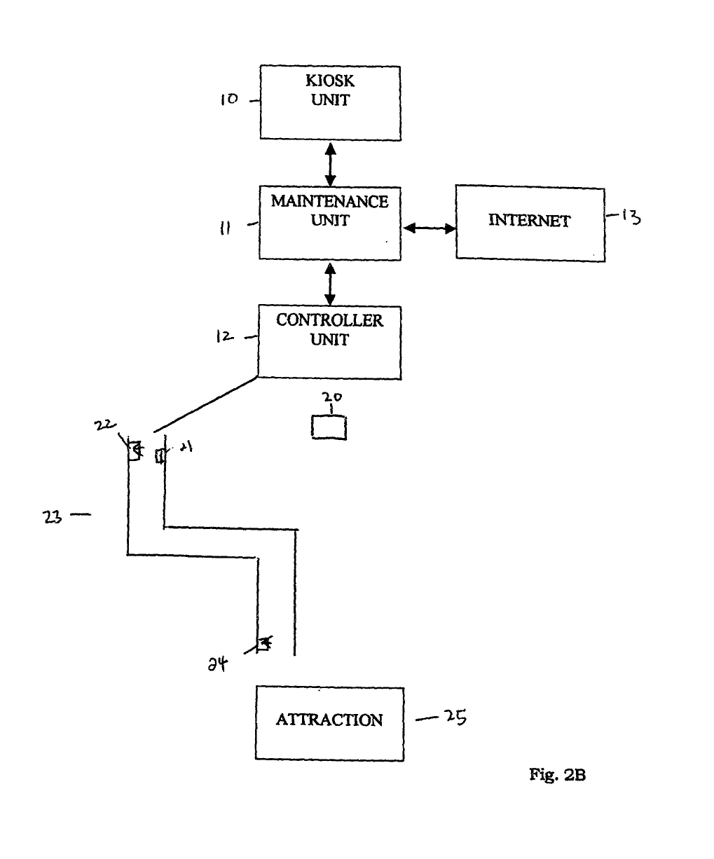

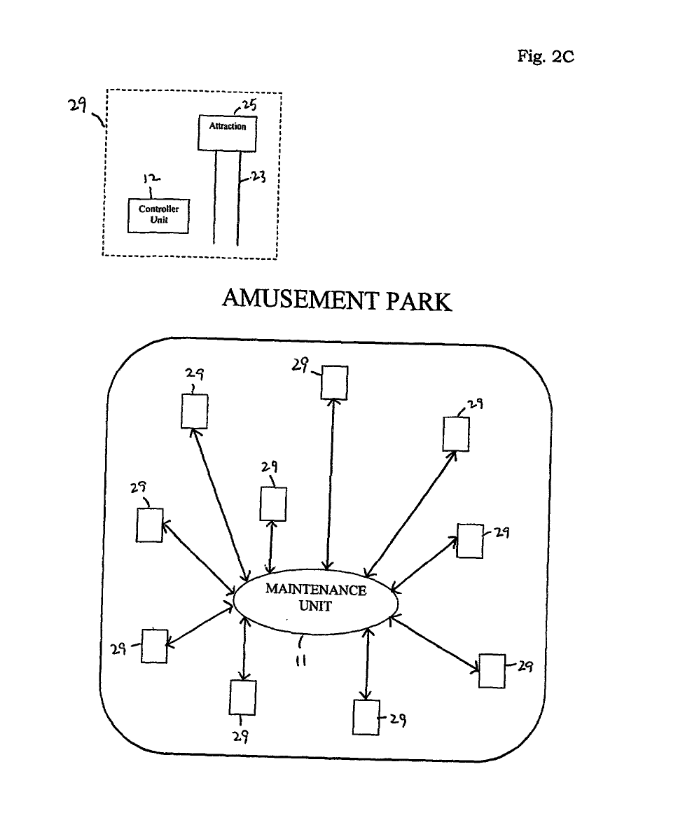

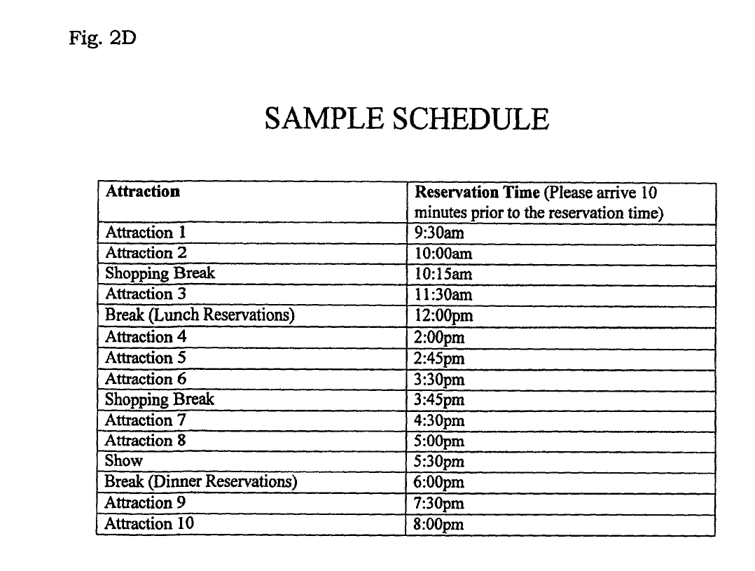

FIG. 2A is a schematic diagram of the system. The guest first accesses one of the available kiosk units 10 or gains access through the World Wide Web/Internet 13. The kiosk unit 10 or World Wide Web/Internet 13 then interfaces with the maintenance unit 11, which then interfaces with the controller unit 12. In a preferred embodiment, the controller unit 12 controls the reservation queue 23 and the non-reservation queue 28, however, another unit such as the maintenance unit 11 or other central unit can control the queues as well. The queue limits entry through the use of various barriers. Barriers are generally turnstiles but they are not limited to such and may take the form of any device which aids in the preventing access. In one embodiment, the reservation queue 23 contains a first turnstile 22 and a scanner 21 to limit entry into the reservation queue 23 to valid ticket or reservation holders. A second turnstile 24 is used to permit entry into the attraction 25. The non-reservation queue 28 also contains a first turnstile 27 used to keep track of the number of guests waiting in the non-reservation queue 28. The first turnstile 27 of the non-reservation queue 28 contains an electronic counter 26. By keeping track of the number of waiting guests at the non-reservation queue 28, the system can calculate real-time wait times and better manage the two lines. The non-reservation queue also contains a second turnstile 24 to permit entry into the attraction 25. The information displays 20 are used to display wait times for both the reservation queue 23 and the non-reservation queue 28. Additionally, the information display 20 can display a variety of other information or advertisements. The information display 20 may consist of multiple screens. At least one of the screens being larger than the rest to display the wait times as well as various advertisements. The smaller screens may be viewed and accessed by individual guests to obtain personal information as well as general park information. The display monitors may further be accessed through the use of a keyboard, voice interface, mouse, or touch screen monitor.

In one embodiment of the invention, after viewing attraction information at one of the available kiosk units 10, guests can submit reservation requests. The reservation request could be for a single attraction or alternatively it could be for numerous attractions depending on the preference of the ticket holder or the type of ticket the guest holds. Although the number of actual reservations allowed to guests may be altered, one example of a distribution system would be to give single day ticket holders Bronze status, allowing them to have two active reservations, multi-day ticket holders Silver status allowing them to have three active reservations, VIP Tour Guests Gold status and allowing them to have four active reservations, and Hotel Guests Platinum status and allowing them to have five active reservations.

The reservations are then relayed through the maintenance unit 11 to the appropriate controller unit 12. The controller units 12 may be located adjacent to the attraction 25 or alternatively may be located at a remote location.

In an alternate embodiment of the invention, guests may view and purchase pre-sale attraction packages preferably consisting of five (5) to fifteen (15) attractions prior to entering the park. In addition, guests may also purchase a parking pass in advance, make lunch or dinner reservations, and put cash value on their guest identifier. The purchased attraction packages are then relayed through the maintenance unit 11 to the appropriate controller unit 12. Guests are then mailed a confirmation ticket which may be in the form of a card. The card may then be used at the park to access the system. The data may be stored on the card itself or alternatively, be stored at the park and accessible by card.

Guests who purchase a parking pass in advance, may enter into the parking lot of the park by having their identification card verified at the parking gate. They may also bypass all lines at the ticketing booth at the entrance of the park by having their guest identifier verified by the scanners at the park entrance.

Upon arrival at the appropriate attraction at the designated time (preferably between 10-15 minutes before the beginning of their specified reservation period), the guest enters the reservation queue 23 designated for reservation holders and valid advanced ticket purchasers. The reservation queue 23 and the non-reservation queues 28 are controlled by the controller unit 12. The controller unit 12 controls the processes at the reservation 23 and non-reservation queues 28 and/or displays the necessary information to the employee overseeing the attraction. The reservation queue 23 contains a first turnstile 22 where the guest's ticket or other identifying means is verified for the correct attraction and time via an employee or alternatively through a scanner 21.

In one embodiment of the invention, a scanner 21 located at the first turnstile 22 of the reservation queue 23 can be used to authenticate the reservations by reading the guest's ticket, reservation slip, or bodily identification such as retinal, fingerprint, voice, etc. Upon verification by the scanner 21, the controller unit 12 can signal the first turnstile 22 of the reservation queue 23 to allow access into the queue. Once the guest has passed through the first turnstile 22 of the reservation queue 23, they will be stopped by a second turnstile 24 which will allow access to the attraction when it becomes available.

Those without prior reservations may enter the non-reservation queue 28 for non-reservation holders. Guests wishing to access the non-reservation queue 28 simply enter through the first turnstile 27 of the non-reservation queue 28 which contains an electronic counter 26, proceed through the queue and wait at the end of the line. The electronic counter 26 transmits this data to the maintenance unit 11, which uses it to manage the two lines and calculate estimated wait times.

The attraction 25 in question could be for a ride, show, event, food place, store, museum, or any other location where the guest wishes to gain admittance without waiting in a line.

In one embodiment of the present invention, wait times for the attraction for both the reservation queue 23 and non-reservation queue 28 may be posted on the information display 20 to help the guest make a more informed decision when deciding to wait in the non-reservation queue 28 or try to make a reservation at one of the kiosk units 10. Additionally, the information display 20 may further be accessible through a keyboard, mouse, voice interface, touch screen monitor or other interface system to enable guests retrieve their own personal or general park information. The information display 20 may further be comprised of multiple screens of different sizes enabling one of the larger screens to display wait times and advertisements while the smaller screens are reserved for individual guests to view and access personal or park information. Alternatively, the display monitor 20 may also contain a scanner to read the guest's identification card 30 to facilitate the retrieval of personal information.

The wait time for the non-reservation queue 28 can be calculated from a variety of factors such as the number of guests in line and the total number of guests that can complete the attraction in a given amount of time.

In one embodiment of the present invention, a park attendant activates the appropriate Limit file. A Limit file contains a series of sub-files by park with the maximum number of reservations that could be allowed for each attraction using a combination of attendance levels and operation hours. Operations personnel would be responsible for activating the correct file each day. This would be a dynamic process and the active file could be changed during the day should attendance levels change. The changing of the active file would not require a reboot of the system and would not affect previously scheduled reservations.

After activation of the Limit file, the system would validate the current date against the Attraction Status file which contains the attraction ID, zone location, the maximum reservations per period (based on Limit sub-file loaded), and the number of reservations booked for that time slot. The Attractions Status file would be used to change reservation times being accepted. If a different date, a new Attraction Status file will be loaded. If the same date, a new reservation limits would be loaded, overlaying those previously used from the next increment forward. This would be accomplished using a custom application.

Then as the reservations are redeemed, the information about the ticket is passed to the Ticket Control file in a real-time mode. The Ticket Control file contains the data on reservations that have been redeemed for the current day for each guest of the park.

Alternatively, FIG. 2B refers to a system where the entire day is composed for the guests and wherein the guests are able to participate in virtually every attraction at the park. Guests are admitted into the park only with advanced reservations or with advanced ticket purchases. All guests are divided into a number of groups (number of groups will be determined by the number of attractions and number of time blocks for each attraction). Then each group is assigned reservation times for each of the attractions. Each group rotates throughout the park from attraction to attraction enabling all guests to participate in every attraction with virtually no wait times. In this embodiment, there are no non-reservation queues 28.

FIG. 2C provides an overview of a park wherein every attraction 25 is accessible only through a reservation queue 23. Each attraction unit 29 contains an attraction 25, a reservation queue 23, and a controller unit 12. Each of the controller units 12 communicates with the maintenance unit 11 to enable the maintenance unit 11 to control park operations and to ensure that all data and information is current. All the guests are divided amongst each of the attractions 25 and each of the guests have reservation times for every attraction 25 within the park. When the guest completes an attraction 25, they move to the next scheduled attraction 25 or scheduled break until every guest has attended every attraction 25.

FIG. 2D displays a sample schedule for a guest with reservations for every attraction including breaks and meals. The sample schedule allows the guest to attend ten attractions and have breaks for meals, shows, or shopping. This schedule may also be printed and given to the guest for easy reference (such as on the identification card, ticket stub, or program). Alternatively, the schedule along with any other personal guest information may be accessible by the guest at any of the kiosk units 10, information displays 20, or from stored electronic media.

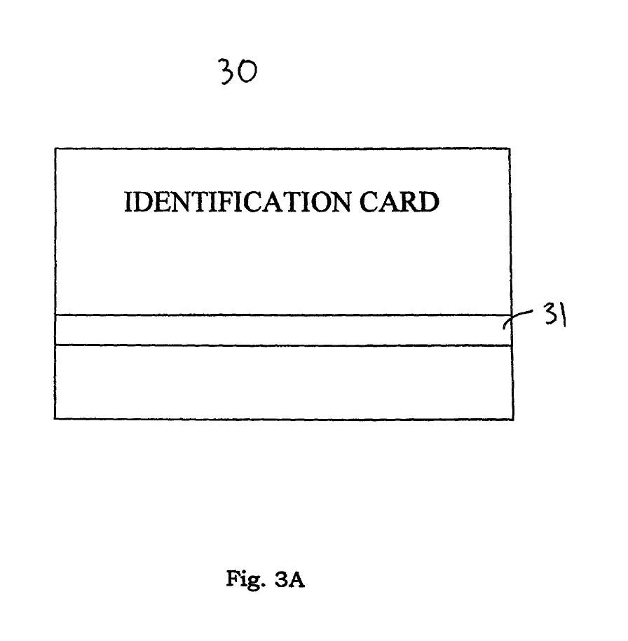

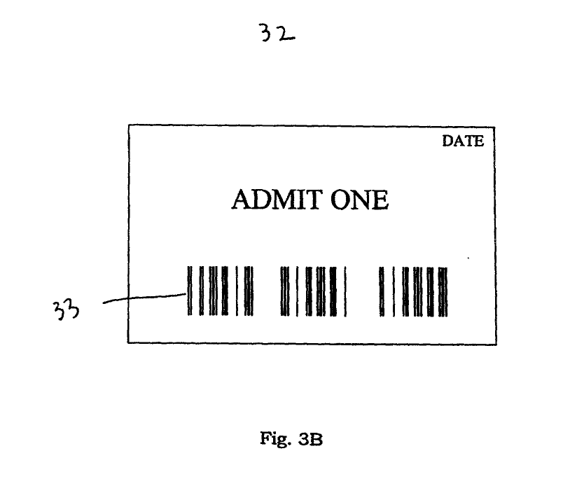

Guests may gain access, be tracked, and be identified through any appropriate device that is capable of data storage and/or accessing other system components. FIG. 3A illustrates the preferred embodiment of identifying guests and accessing other system components through the use of an identification card 30. FIG. 3B illustrates the ticket stub 32 which can also be used to access the kiosk unit 10. In one embodiment of the present invention, access to the kiosk unit 10 may be obtained through the use of the identification cards 30. The identification cards 30 are issued to each guest as they enter the park or alternatively are mailed to those with advance ticket purchases. For children under a certain age, they may be identified with a parent's identification card 30. In these instances, the parent's identification card 30 will represent the parent and the number of children they wish to include. Thus every reservation will represent the adult and their children.

In one embodiment, the identification cards 30 each contain a magnetic stripe 31 which will identify the guest and keep track of all transactions conducted for that particular guest. Each time the guest wishes to access a kiosk unit 10 or obtain access into an attraction, they will have to obtain verification as a valid ticket holder through their identification card 30. The maintenance unit 11 will then keep a record of all transactions in its database. Additionally, such identification cards 30 may also be used as a type of credit or debit card throughout the park by purchasing credits in advance or alternatively by linking the identification card 30 transactions with the guest's credit card so that all purchases could be billed to their credit cards.

In another embodiment of the present invention, the ticket stub 32 the guest receives from the ticket booth as their receipt will act in much the same way as their identification cards 30. The ticket stubs 32 will contain a magnetic stripe, bar code 33, or other volatile or non-volatile memory/data storage element which the kiosk units 10 will be able to access and read. This will enable verification of the guest as a valid ticket holder and maintain a record of all their transactions.

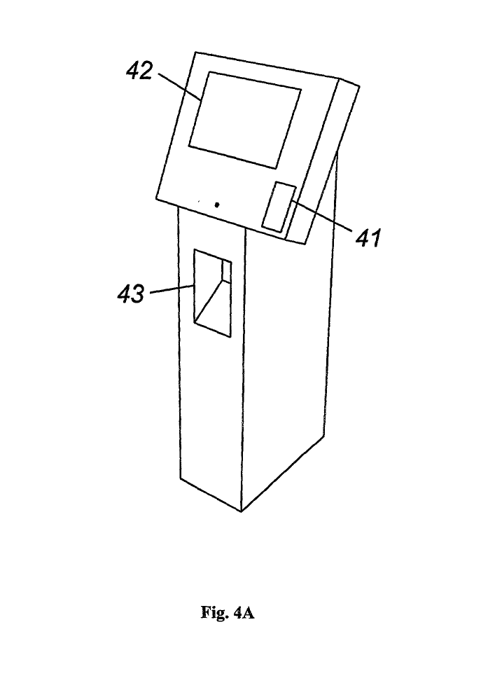

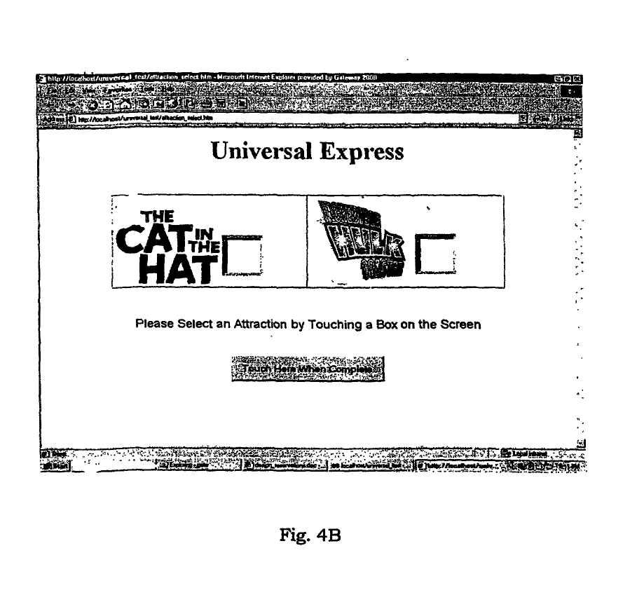

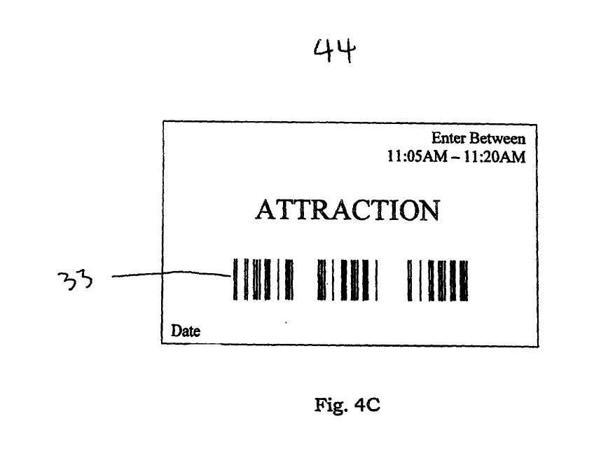

FIG. 4A illustrates the kiosk unit 10 which can be accessed by guests for information and requests for reservations. The kiosk units 10 will use a touch screen display 42 to view the information and receive requests, a card reader 41 to read identification cards 30, and a printer 43 which enables guests to obtain ticket stubs 32 for verification or printed copies of anything they view on the touch screen display 42.

In one embodiment of the invention, data containing the parks general information such as hours of operations, a park directory, updates of events occurring at the park, wait times for various attractions, and available reservation times are stored in the data storage unit of the kiosk unit 10. This information is constantly updated from the maintenance unit 11.

In one embodiment of the invention, guests slide their identification cards 30 or other identifying means through the reader 41 which reads the identification card 30 to verify they are valid ticket holders. Alternatively, guests may scan ticket stubs 32 to properly identify themselves and gain access to the kiosk units 10. Once access is granted, the guest may view a variety of information as well as make reservations through the use of a touch screen display 42.

FIG. 4B gives an illustration of the touch screen display 42 once the kiosk unit 10 has been activated. The kiosk unit 10 can display the attractions that are available for selection. If the guest has reservation slots available, the guest may make additional selections. The guest will then be directed to select the requested reservation time for each attraction. The kiosk unit 10 then transmits this data to the maintenance unit 11.

The maintenance unit 11 then updates its data files to reflect the new reservations. Upon completion, the kiosk unit 10 will print the confirmed reservation schedule through its printer 43. FIG. 4C shows a sample print out with the confirmed schedule of reservations. The confirmation ticket 44 includes a bar code 33 for verification purposes, the name of the attraction, and recommended time of arrival. It is also noted that additional information can also be printed on the confirmation ticket 44 such as advertisements, location of the attractions, things to do near the reserved attraction, etc.

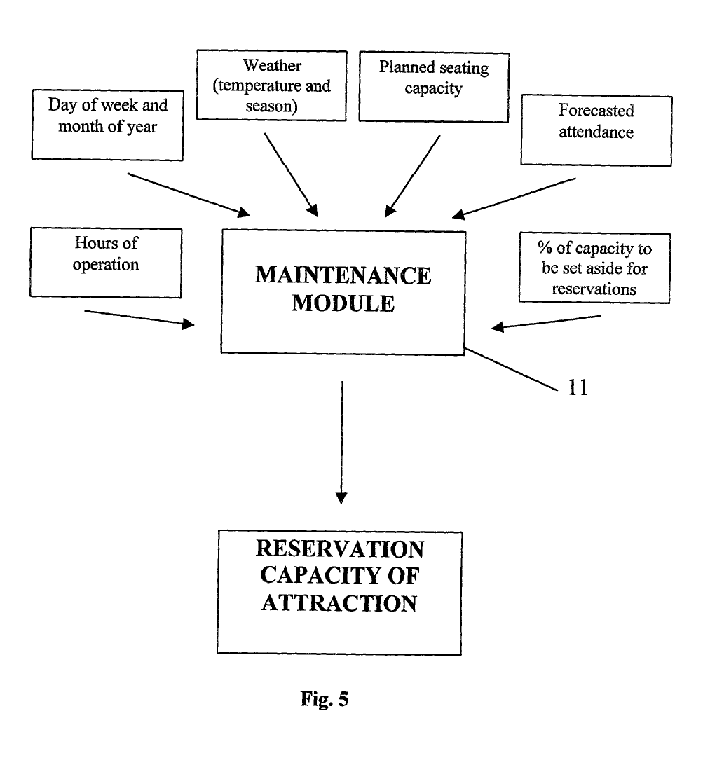

The sales for advance attraction packages and the requests for reservations are processed by the maintenance unit 11. The maintenance unit 11 is the central processor and principal manager of the entire system. FIG. 5 shows a flow chart of data that is input into the maintenance unit 11. Data necessary for calculating the number of reservations to be offered could consist of the day of the week, the month of the year, forecasted attendance, hours of operation, the days temperature range, planned seating capacity of attractions, as well as any other relevant data used in determining reservation capacity for an attraction. From the data obtained, and through the use of a predetermined algorithmic formula, the maintenance unit 11 calculates the perceived number of reservations that will likely be cancelled and formulates the number of reservations that will be made available for each cycle of an attraction.

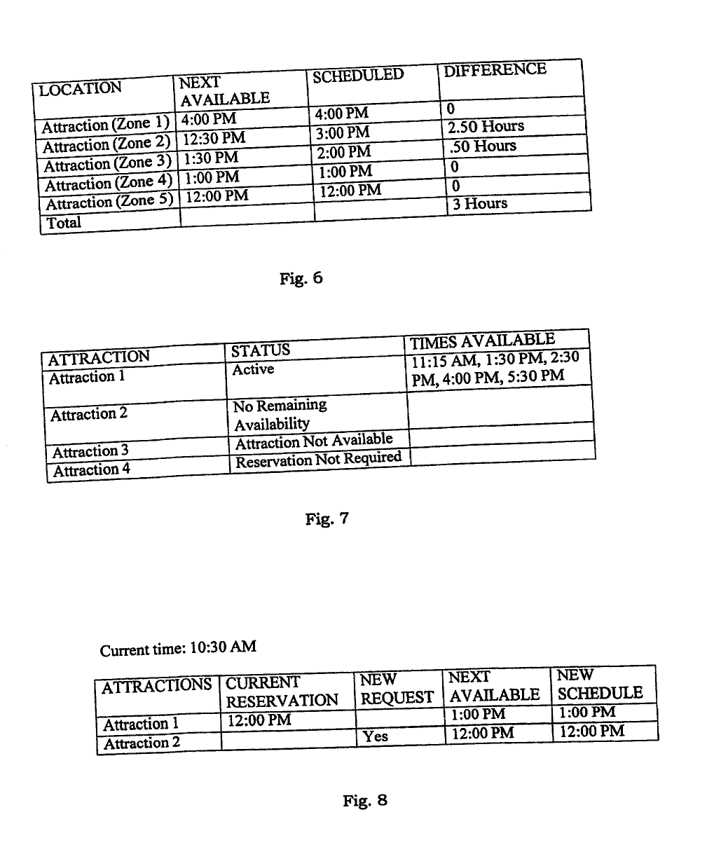

The maintenance unit 11 can be set up for any ratio of reserved to non-reserved seating. From the data received, the maintenance unit 11 formulates the number of reservations available for each cycle of an attraction and designates the reservation capacity. FIG. 6 illustrates a hypothetical schedule that has optimized the guest's time. An optimal schedule is one containing the least difference in time between the requesting times and reserved times. The optimal schedule also takes into account attraction to attraction walk times and meal breaks. When the guest's identification card 30 or other identifying means is scanned, the application will determine the ticket type and all operating and available attractions located in the park will be displayed and grouped by zones of geographic proximity, simply alphabetically, in categories based upon popularity, or some other classification system to aid the guest in their selection process. Depending on the guest's ticket type, a message will be displayed indicating the number of active reservations the guest is entitle to hold at one time (e.g. 5 active reservations for a multi-day pass holder or as low as two for a single day ticket holder). If the guest only wishes to make one reservation, the system will assign the time closest to the requested time from among those reservation times available for the particular attraction.

In one or more embodiments, if the guest wishes to make multiple reservations, the guest may select the desired attractions and allow the system to calculate the optimal schedule taking into account the walk times, length of attraction time, and break times for lunch and dinner. “Optimal” schedule is defined as the schedule that best fulfills the guests requests while adhering to certain park constraints. In this case, that means a schedule that can fit all the requested attractions without any conflicts in an order that takes the guest from region to region without too much backtracking and contains reservation times spread apart enough to enable the guest to enjoy other aspects or attractions of the park in between the scheduled attractions. The system optionally also seeks to equitably spread guests throughout the park so that no portion of the park is overly crowded. Alternatively, the guest may request particular times for each of the requested attractions and form their own schedules. In yet another embodiment of the present invention, guests may select the desired attraction and preferred attraction time and allow the system to calculate the optimal schedule. The “optimal” schedule in this case being the least amount of time difference between the requested reservation times and the actual reservation times. Moreover, it is further defined as cases where active reservations are shifted in time in order to accommodate new requests without eliminating attractions from the reservation list. For all selections, the park may dictate certain parameters of the system. For example, attractions may be grouped into categories that reflect its popularity. Guests may then be allowed to chose a limited number of attractions from each category. The categories may be based upon geography, popularity, or any other specification designated by the park. Additionally, the guest may restrict certain parameters. For instance, they may require that lunch is from 1:00pm to 2:00pm so that members of a large group can all meet together at a particular time.

If the guest wishes to make multiple selections, the application will select an optimal schedule for each selected attraction based on the following logic:

In one embodiment of the present invention, guests enter the attractions they desire up to their reservation limit as well as the time they wish to depart from the park. The attraction with the earliest availability, and with a start time later than the current time plus walk time to the attraction will be reserved first. The Attraction Movement Time table will include kiosk unit 10 to attraction movement times. The earliest available time slot is defined as the one for the selected attraction that is not completely booked, has a start time later than the current time plus walk time from the kiosk unit 10 to the attraction, and is closest to the current time.

Using predefined attraction-to-attraction routings, a number of different routes will be calculated, adding attraction-to-attraction walk time, buffer time for enjoying the attraction and the surrounding area, and lunch/dinner time allocations between attractions. The route which fills the entire time and allows for breaks for lunch and/or dinner will be selected, and attraction reservations made accordingly.

A table of attraction-to-attraction movement times will be maintained. A table containing the number of minutes to be allocated for lunch and dinner will also be maintained. Associated lunch start and stop times and dinner start and stop times plus the number of minutes that must be reserved for a meal during those timeframes is maintained for each combination of operating hours and estimated attendance figures.

In an alternative embodiment of the present invention guests may choose the attractions as well as the preferred time for each attraction. This method gives the guest more control over their schedule and the route they wish to take around the park. This method can be used as an alternative to the previously mentioned optimal schedule method or in conjunction with it for guests who wish to make some reservations early and fill their remaining reservations at a later time or for guests who have completed certain reservations and wish to request new ones. After the guest has swiped his/her identification card 30 the same list of attractions grouped by categories or grouped alphabetically will be displayed. A message will be displayed on the touch screen 42 indicating the number of attractions that may be selected dependent upon the number of active reservations allowed for the particular guest.

The logic behind this second distribution process is as follows:

If the maximum number of attractions that can be selected from the kiosk unit 10 is less than the remaining active reservations allowed (number of active reservations for the ticket type minus the current number of active reservations for the ticket type), a message indicating the maximum number of attractions that can be selected from the kiosk unit 10 will be displayed. For example, if the guest's ticket type allows four active reservations and the guest currently has one active reservation, the remaining reservations allowed would be three. In the case where certain attractions can only be selected at certain kiosk units 10 then that may be the limiting factor. Certain attractions may be limited to certain kiosk units 10 to urge guests to enter those zones. Therefore, if the particular kiosk unit 10 only allows two attractions to be selected, the message displayed would indicate that the guest could select two attractions.

If the maximum number of attractions that can be selected from the kiosk unit 10 is greater than or equal to the remaining active reservations allowed, a message indicating the number of reservations allowed will be displayed. For example, if the guest's ticket type allows four active reservations and the guest currently has one active reservation, the remaining reservations allowed for that guest would be three. Even if the kiosk unit 10 allows four attractions to be selected, the message displayed would indicate that the guest could select three attractions.

In addition to the number of attractions that can be selected, FIG. 7 shows messages that may be displayed for each attraction and indicates its status. If the attraction is in “active” status with remaining availability for reservations that day, the normal icon will be displayed and the attraction can be selected by the guest. If the attraction is in “active” status with no remaining availability for reservations that day, a “No Remaining Availability” icon will be displayed and the attraction may not be selected by the guest. If the attraction is in “hold” status, an “Attraction Not Available” icon will be displayed and the attraction may not be selected by the guest. If the attraction is in “reservation not required” status, a “Reservation Not Required” message will be displayed and the attraction may not be selected by the guest.

Requests are then processed according to a particular system. If the guest has no active reservations, then they are given the choice of choosing between the two closest available time to the requested time for the attraction that was selected by the guest.

If the guest has one active reservation and the closest available time to the requested time for the second attraction is before or after the first active reservation time, the maintenance unit 11 will determine if the walk time and buffer time between attractions allows enough time for the guest to attend both attractions. If there is enough time, the reservation will be made. If there is not enough time to get to the second attraction, then the next closest available time to the requested time will be reserved.

If the only available time for the second reservation is during the time of the first reservation, then the maintenance unit 11 will seek out alternative times for the first reservation based upon the above described logic in order to maintain the guest's optimal schedule. If the system finds that the first reservation can be moved close to the second requested time and the second requested time can be moved into the first requested time, then the first reservation will be moved to the second requested time and the second reservation request will be moved to the first reservation time. In this manner, the guest's schedule will be rescheduled to enable the guest to enjoy both attractions at the times they requested.

If the guest has more than one active reservation, and the closest available time to the subsequent request for a reservation is before or after one of the prior reservation, the maintenance unit 11 will determine if the walk time and buffer time between attractions allows enough time for the guest to attend all attractions. If there is enough time, the reservation will be made. If there is not enough time to get to the subsequent attraction, then the next closest available time to the requested time will be reserved.

If the only available time for the subsequent reservation is already taken by one of the preceding reservations, then the system will seek out alternative times for the active reservation which holds the only available time for the most recent reservation request based upon the above described logic. If the system finds that one of the active reservations can be moved close to the last requested time and the last requested time for an attraction can be moved to one of the active reservations, then the active reservation will be moved to the last requested time and the last reservation request will be moved to the active reservation time. If that particular active reservation cannot be moved to the last requested time, then the system will check to see if any of the other active reservation can be filled in any of the other active reservation times and whether any of those times could be filled in the last requested time. If that is possible, then as many of the active reservations will be moved around to enable all the requests to be filled. In this manner, the guest will be able to enjoy all the requested attractions at times they requested. During any point of the reservation process, the guest may reject changes or suggestions and the system will go back to the last confirmed set of reservations.

FIG. 8 illustrates how in all cases, the reservations are in a constant state of flux. If a prior reservation is better served by being moved, the first reservation will be moved to better accommodate the schedule and achieve the optimal schedule.

In yet another embodiment of the present invention, if the guest does not wish to rearrange their schedule, they can request the kiosk unit 10 to list only the attractions with attraction times that can fit into their present schedule. From there, the guest can select as many of the attraction they wish for the time they wish up the maximum limit of active reservation allowed for that particular guest.

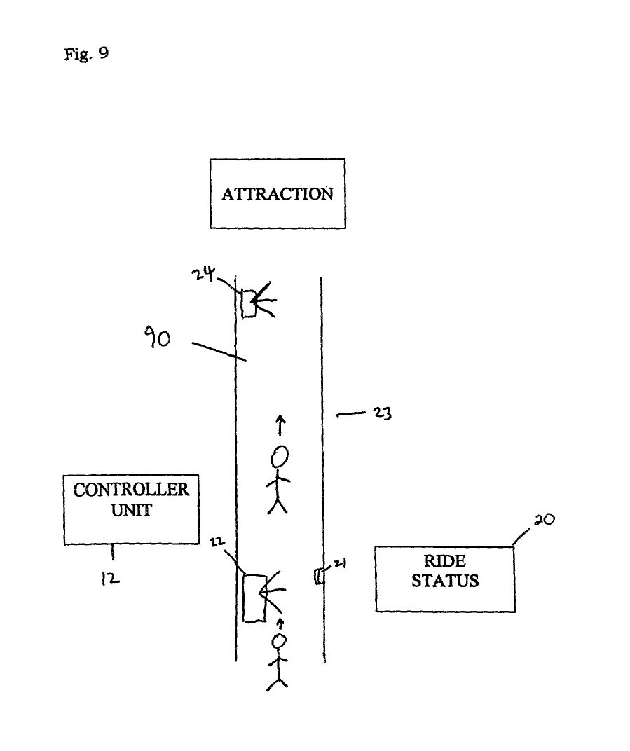

FIG. 9 illustrates how the reservations are redeemed. Once the guest has obtained the reservation, they simply go to the chosen attraction at the appointed time. After arrival at the attraction, reservation holders access a first turnstile 22 in the reservation queue 23. The first turnstile 22 of the reservation queue 23 is controlled by the controller unit 12 to enable reservation holders to enter. Valid reservation and ticket holders must be confirmed by a scanner 21 to gain entry into the reservation queue 23 through the first turnstile 22. The controller unit 12 accesses its data banks and verifies that the guest has arrived at the correct attraction at the correct time. Once through the first turnstile 22, the guest can proceed through the reservation queue 23 up to the second turnstile 24 and wait in the waiting area 90. The wait time before being allowed to enter the attraction would likely be around 10-15 minutes. Once the confirmation ticket 44 has been accepted, the data is transmitted to the maintenance unit 11 so that its system may be updated with the most current data.

The data that is continuously transmitted from the controller unit 12 to the maintenance unit 11 enables the maintenance unit 11 to modify the ratio of reservation holders and non-reservation holders on each cycle of the attraction to ensure that reservations times remain unchanged. If the ride is running a little slow and a backlog of reservation holders are forming, then a few extra reservation holders are allowed access. If the ride is running a little fast or there have been a lot of cancelled reservations, then extra guests from the non-reservation queue fills the extra space. Although most reservations will remain unchanged, guests may receive updates regarding their reservations at any time through any of the numerous kiosk units 10 or view the information displays (containing ride status) 20 located near the attraction. The information displays 20, along with other park information and advertisements would display the current reservation times that are being accepted, notification of any delays, and expected wait times for the attraction.

At the end of the day, guests exiting the park may deposit their identification cards 30 to be recycled for the next day. Guests may be encouraged to recycle the identification cards 30 by a variety of methods such as offering discount coupons for returning the identification cards 30 or requiring refundable deposits when the identification cards 30 are issued. Alternatively, identification cards 30 could be designed to be taken home by guests as a souvenir by containing characters from the park.

While the foregoing embodiments and methods have been described, it would be apparent to those skilled in the art that many more modifications are possible without departing from the inventive concepts herein. The invention, therefore, is not to be restricted except in the spirit of the appended claims.

What is claimed is:

1. A reservation system for scheduling admission of guests into attractions comprising:
an input/output device;
a maintenance unit linked to said input/output device to store, receive, send, and process data wherein a portion of said processed data is the scheduling of a limited number of active reservations; and
a controller unit linked to the maintenance unit for directing access into the attraction.

2. The system of claim 1, where said input/output device comprises:
an interface system for guests to communicate with said input/output device;
an identifier device to enable said input/output device to identify valid ticket holders;
a money receiver to enable said input/output device to receive cash and credit card payments;
a processor to process and evaluate data submitted to said input/output device;
a transmission device to receive and send data to and from said input/output device;
a storage device to store data within said input/output device; and
a printer to print tickets or information from said input/output device.

3. The system of claim 2, where said interface system enables communication between the guest and said input/output device through an interface device selected from the group consisting of a keyboard, a mouse, a touch screen monitor, or voice recognition system.

4. The system of claim 3, where said touch screen monitor enables guests to access information concerning the park by touching the screen.

5. The system of claim 2, where said identifier device identifies guests and relays the information to said maintenance unit.

6. The system of claim 5, where said identifier identifies guests by accessing stored information of a guest accessed by a guest card.

7. The system of claim 2, where said transmission device sends and receives data through a connection device selected from the group consisting of a phone, cable lines, or satellite transmission.

8. The system of claim 2, where said printer may print confirmed reservations, maps, other general park information, or data stored in said storage device.

9. The system of claim 2, where said money receiver receives money and adds value to said guest card which can be used like a debit or credit card throughout the park.

10. The system of claim 1, where said maintenance unit comprises:
a storage device to store data within said maintenance unit;
a transmission device to receive and send data to and from other devices;
a processor within said maintenance unit capable of performing multiple functions and calculations; and
an input device to enable employees to manually input data into said maintenance unit.

11. The system of claim 10, where said transmission device is able to receive and send data through a connection device selected from the group consisting of a phone, cable line, or satellite transmission.

12. The system of claim 10, where said processor is capable of verifying valid ticket holders, using algorithms to compute optimal reservation times and seating capacity, as well as controlling park functions.

13. The system of claim 8, where said storage device can store data regarding attractions, park functions, general park information, maps, real-time wait times, maintain all of a guest's personal data including personal preferences and history of transactions, confirmed reservations and reservation availability.

14. The system of claim 13, where said real-time wait time data is received from said controller unit.

15. The system of claim 10, where said processor will manage the reservation and admission process by directing the controller unit and input/output device to fully utilize each attraction.

16. The system of claim 1, where said controller unit comprises:
a storage device to store data within said controller unit;
a processor to run the functions of said controller unit;
a transmission device to receive and send data to and from said controller unit to other devices;
a queue system linked to the controller unit to control entry into the attraction;
an access terminal for manual entry of data into said controller unit; and
a display monitor linked to said controller unit to enable guests to view and access wait times for non-reservation queue and next available times for reservation queues, personal information, and park information.

17. The system of claim 16, where said storage device stores reservations received from the maintenance unit.

18. The system of claim 16, where said processor of the controller unit is able to process the information received from the maintenance unit and able to direct the reservation queue and non-reservation queue.

19. The system of claim 16, where said transmission device receives and sends data through a connection device selected from the group consisting of a phone, cable line, or satellite transmission.

20. The system of claim 16, where said access terminal is used by employees when there is a need to input data manually into the controller unit.

21. The system of claim 16, where said access terminal is accessible through an interface device selected from the group consisting of a keyboard, mouse, voice interface, or touch screen monitor.

22. The system of claim 16, where said display monitor contains multiple screens that may be viewed and accessed by guests through an interface device selected from the group consisting of a keyboard, voice interface, mouse, touch screen monitor, or scanner that identifies said guests.

23. The system of claim 16, where said controller is linked to a queue system consisting of a reservation queue and a non-reservation queue.

24. The system of claim 23, where said reservation queue comprises:
a barrier device linked to said controller device which limits entry into said reservation queue to valid reservation holders;
an identifier device linked to said controller device which identifies valid reservation holders to said controller device; and
a second barrier device linked to said controller unit which limits entry into the attraction until the attraction is available.

25. The system of claim 23, where said non-reservation queue comprises:
a counting device linked to said controller unit which counts the number of guests waiting in the non-reservation queue; and
a barrier device linked to said controller unit which limits entry into the attraction until it is available.

26. A method for scheduling admission of guests into attractions comprising the steps of:
making a reservation at an input/output device prior to the guest's arrival at an attraction;
relaying that request from said input/output device to a maintenance unit to be processed and calculated to optimize the guest's schedule;
relaying the proposed schedule from said maintenance unit back to the input/output device to be accepted or rejected by the guest;
relaying the acceptance or rejection from the input/output device to the maintenance unit in order to be updated by the data files of the system;
relaying the confirmed reservation from the maintenance unit to a controller unit to enable valid reservation holders to gain access into a reservation queue; and
working in conjunction with a non-reservation queue to maximize attraction capacity by filling non-reserved seats with waiting guests.

27. The method in accordance with claim 26, where said input/output device may be accessed only by valid ticket holders.

28. The method in accordance with claim 27, where said input/output device uses an identifying device able to obtain information through an accessing device selected from the group consisting of a magnetic stripe, a bar code, or a microchip.

29. The method in accordance with claim 26, where said input/output device allows information and reservations to be accessed through an interface device selected from the group consisting of a touch screen monitor, keyboard, mouse, or voice interface.

30. The method in accordance with claim 26, where said input/output device provides information concerning general park information, specific attraction information including news, updates, attraction description, wait times, reservation times still available, or general park information.

31. The method in accordance with claim 26, where said input/output device enables guests to make a selection for an attraction by choosing attractions, available times, or preferred times for attractions.

32. The method in accordance with claim 30, where said selection may be for a single attraction or a plurality of attractions.

33. The method in accordance with claim 30, where said selection may be limited by a predetermined parameter.

34. The method in accordance with claim 33, where said predetermined parameters are to limit the number of selections from a particular category of attractions categorized by geography or popularity.

35. The method in accordance with claim 33, where the number of said selections allotted to each guest is limited to a certain number of active reservations by the type of ticket a ticket holder is issued.

36. The method in accordance with claim 35, where said ticket holders are divided according to a system comprising:
bronze level ticket holders allowed two active reservations;
silver level ticket holders allowed three active reservations;
gold level ticket holders allowed four active reservations; and
platinum level ticket holders allowed five active reservations.

37. The method in accordance with claim 31, where said selections of attractions are then relayed to said maintenance unit.

38. The method in accordance with claim 26, where said schedule is designed to optimize the time of the guest based upon the requested attractions enabling the guest to enjoy as many of the requested attractions as possible in the allotted time without any conflicts and with time in between attractions to enjoy other attractions, meals, shops, and shows.

39. The method in accordance with claim 26, where said maintenance unit evaluates the request using an algorithm.

40. The method in accordance with claim 39, where said algorithm is designed to enable the guest to attend as many of the requested attractions with the least amount of time difference from the requested times all within the time frame requested by the guest while adhering to certain predetermined parameters to ensure favorable and maximum usage of the park.

41. The method in accordance with claim 26, where a guest's schedule can be further optimized by being rescheduled so that current reservations can be changed to accommodate both previous and current requests without losing the previous reservations.

42. The method in accordance with claim 41, where current reservations can be rescheduled to fit new requests without losing previously confirmed reservations by moving the previously confirmed reservation to a new time and placing the new request into the previously confirmed time slot.

43. The method in accordance with claim 40, where said algorithm takes into account a number of variables including the time of year, current park attendance levels, the day of the week, the time of the month, the weather, the length of time to complete the attraction, the time it takes to walk from attraction to attraction, the time it takes for meals, the seating capacity of said attraction, the guest's prior reservation schedule and available number of reservations, the ratio of reservation holders to non-reservation holders allowed for said attraction, forecasted attendance, and other restrictions favorable to the movement and management of guests in and around a theme park.

44. The method in accordance with claim 39, where said algorithm results are relayed back to said input/output device to be accepted or rejected by said guest.

45. The method in accordance with claim 29, where said input/output device displays said schedule is relayed to the guest for acceptance or rejection.

46. The method in accordance with claim 45, where said acceptance is relayed back to said maintenance unit to be stored into a storage device.

47. The method in accordance with claim 45, where said schedule containing reservations are relayed to the appropriate controller unit.

48. The method in accordance with claim 47, where said controller unit stores the confirmed reservation into a data storage device.

49. The method in accordance with claim 26, where said attraction is accessed through two queues comprising:
a reservation queue for guests who have reserved a position in advance; and
a non-reservation queue for guests wishing to arrive at said attraction and wait for the next available seating.

50. The method in accordance with claim 26, where said maintenance unit works in conjunction with said controller to manage access to each attraction so as to fill each attraction to full capacity.

51. The method in accordance with claim 50, where said maintenance unit directs said controller unit to fill unclaimed reservation seats with guests waiting in said non-reservation queue.

52. The method in accordance with claim 49, where said controller unit exerts control over a system of two queues by limiting access to a reservation queue to valid reservation holders and keeping track of the number of guests waiting in said non-reservation queue.

53. The method in accordance with claim 49, where said reservation queue is accessed by guests with a guest card.

54. The method in accordance with claim 53, where said guest card contains an accessing device selected from the group consisting of a magnetic stripe, bar code, or microchip.

55. The method in accordance with claim 26, where said controller unit displays wait times for said non-reservation queue and the reservation times that remain available on a display monitor.

56. The method in accordance with claim 55, where said display monitor consists of multiple screens and an interface device to enable guests to access personal information.

57. The method in accordance with claim 49, where said reservation queue verifies valid reservation holders through the use of an identifying device.

58. The method in accordance with claim 57, where said identifying device is a scanner capable of reading data from an accessing device selected from the group consisting of a magnetic stripe, bar code, or microchip.

59. The method in accordance with claim 49, where said reservation queue limits entrance into said reservation queue to valid reservation holders through the use of a barrier device.

60. The method in accordance with claim 59, where said barrier device allows entry only upon verification by said identifying device.

61. The method in accordance with claim 49, where said reservation queue limits entrance to said attraction until the attraction is available through the use of a second barrier device.

62. The method in accordance with claim 49, where said non-reservation queue includes a counting device to count the number of guests entering said non-reservation queue.

63. The method in accordance with claim 62, where said number of guests waiting in the non-reservation queue is relayed to said maintenance unit.

64. The method in accordance with claim 62, where said non-reservation queue wait times are determined through the use of an algorithm.

65. The method in accordance with claim 64, where said algorithm takes into account the length of time to complete the attraction, the seating capacity, and non-operating times for an attraction to determine a wait time associated with said attraction.

66. The method of claim 65, where said wait time is relayed back to said controller unit to be displayed on a display monitor for guests to observe.

67. The method of claim 49, where said non-reservation queue includes a second barrier device to limit entrance into said attraction until the attraction is available.

68. A method for scheduling admission of guests into attractions comprising the steps of:
making a reservation request prior to the guest's arrival at an attraction up to the previously set limit for a particular ticket holder;
relaying that request to a central processor to be processed and calculated to optimize the guest's schedule or reschedule the current schedule to include as many of the requested attractions subject to any limiting predetermined parameters;
relaying the proposed schedule to the guest to be accepted or rejected;
relaying the acceptance or rejection back to the central processor in order to be updated into the system;
relaying the confirmed reservation to the appropriate attractions to enable valid reservation holders to gain access into the attraction at the appropriate time; and
working in conjunction with a non-reservation line to maximize attraction capacity by filling non-reserved seats with waiting guests.

69. A reservation system for scheduling admission of guests into attractions comprising:
an input/output device;
a maintenance unit linked to the input/output device to store, receive, send and process data wherein a portion of said processed data is processing a guest's schedule to accommodate both previous and current requests; and
a controller unit linked to the maintenance unit for directing access into the attraction.

70. A reservation and pre-sale attraction package system for scheduling admission of guests into attractions comprising:
an input/output device;
a maintenance unit linked to said input/output device to store, receive, send, and process date wherein a portion of said processed data is the scheduling and sale of a limited number of active reservations; and
a controller unit linked to the maintenance unit for directing access into the park or specific attraction.

71. The system of claim 70, where the input/output device comprises:
an interface system for guests to communicate with said input/output device;
an identifier device to enable said input/output device to identify valid ticket holders;
a processor to process and evaluate data submitted to said input/output device;
a money receiver to enable said input/output device to receive cash and credit card payments;
a transmission device to receive and send data to and from said input/output device;
a ticketing device linked to said maintenance unit that dispenses a guest card;
a storage device to store data within said input/output device; and
a printer to print tickets or information from said input/output device.

72. The system of claim 71, where said interface system enables guests to communicate with said input/output device through an interface device selected from the group consisting of a touch screen monitor, keyboard, mouse, or voice interface system.

73. The system of claim 72, where said touch screen monitor enables guests to access information concerning the park by touching the screen.

74. The system of claim 71, where said identifier device identifies guests and relays the information to said maintenance unit.

75. The system of claim 74, where said identifier device identifies guests by accessing a guest's data through the use of a guest card containing an accessing device selected from the group consisting of a magnetic stripe, a bar code, or a microchip.

76. The system of claim 71, where said transmission device sends and receives data through a connection device selected from the group consisting of a phone line, cable line, or satellite transmission.

77. The system of claim 71, where said printer may print confirmed reservations, maps, general park information, or data stored in said storage device.

78. The system of claim 70, where said maintenance unit comprises:
a storage device to store data within said maintenance unit;
a transmission device to receive and send data to and from other devices;
a processor within said maintenance unit capable of performing multiple functions, calculations; and processing data; and
an input device to enable employees to manually input data into said maintenance unit.

79. The system of claim 78, where said transmission device is able to receive and send data through a connection device selected from the group consisting of a phone line, cable line, or satellite transmission.

80. The system of claim 78, where said processor is capable of verifying valid reservation and ticket holders, using algorithms to compute optimal reservation times and seating capacity, as well as controlling park functions.

81. The system of claim 78, where said storage device can store data regarding attractions, park functions, general park information, maps, real-time wait times, a guest's personal data including personal preferences and history of transactions, pre-sale attraction packages, confirmed reservations and reservation availability.

82. The system of claim 78, where said processor will manage the pre-sale attraction package, reservation, and admission process by directing the controller unit and input/output device to fully utilize each attraction.

83. The system of claim 70, where said controller unit comprises:
a storage device to store data within said controller unit;
a processor to run the functions of said controller unit;
a transmission device to receive and send data to and from said controller unit to other devices;
an access terminal for manual entry of data into said controller unit;
an accessible and viewable display monitor;
a queue system linked to said controller unit to control entry into the parking lot of the park, the park itself, and individual attractions and further comprises:
a parking lot queue for allowing guests who pre-purchased parking passes;
a park queue for allowing pre-sale attraction package holders to enter the park without any lines;
an attraction queue consisting of a reservation queue and a non-reservation queue.

84. The system of claim 83, where said storage device stores reservations received from the maintenance unit.

85. The system of claim 83, where said processor of the controller unit is able to process the information received from the maintenance unit and able to direct the queue systems.

86. The system of claim 83, where said transmission device receives and sends data through a connection device selected from the group consisting of a phone line, cable line, or satellite transmission.

87. The system of claim 83, where said access terminal is used by employees when there is a need to input data manually into the controller unit.

88. The system of claim 83, where said access terminal used by employees contains an interface device selected from the group consisting of a keyboard, mouse, voice interface system, or touch screen monitor.

89. The system of claim 83, where said display monitor contains multiple screens which may be accessed by guests to obtain personal and park information through said interface device selected from the group consisting of a keyboard, mouse, voice interface, touch screen monitor, or scanner that reads guest cards.

90. The system of claim 83, where said attraction queue comprises:
a barrier device linked to said controller device which limits entry into said reservation queue to valid reservation and pre-sale attraction package holders;
an identifier device linked to said controller device which identifies valid reservation and pre-sale attraction package holders to said controller device; and
a second barrier device linked to said controller unit which limits entry into the attraction until the attraction is available.

91. The system of claim 83, where said non-reservation queue comprises:
a counting device linked to said controller unit which counts the number of guests waiting in the non-reservation queue; and
a barrier device linked to said controller unit which limits entry into the attraction until it is available.

92. The system of claim 83, where said parking lot queue comprises:
a blocking device linked to said controller unit which limits entry into the parking lot to guests with pre-purchased parking passes to pass; and
an identifier device linked to said controller unit that reads or scans valid parking pass holders.

93. The system of claim 83, where said park queue comprises:
a barrier device linked to said controller unit which limits entry into the park further comprising:
an identifier device linked to said controller unit that reads or scans for valid pre-sale attraction package holders.

94. A method for selling a pre-sale attraction package for entrance into a park comprising the steps of:
selling said pre-sale attraction package prior to the guest's entrance to said park;
relaying the purchase to a maintenance unit to be processed and updated into the data files of the system;
relaying the confirmed ticket purchase from the maintenance unit to a controller unit to enable valid pre-sale attraction package holders to gain access into the parking lot, the park, or the individual attraction.

95. The method in accordance with claim 94, where said pre-sale attraction package may be purchased over the telephone, on-line through a website, or said input/output device prior to entering the park.

96. The method in accordance with claim 94, where said attraction package may be purchased through an input/output device.

97. The method in accordance with claim 96, where said input/output device allows information and sales to be achieved through an interface device selected from the group consisting of a touch screen monitor, keyboard, mouse, or voice interface system.

98. The method in accordance with claim 96, where said input/output device accepts credit and cash payments and dispenses a guest card used to access the guest's data.

99. The method in accordance with claim 96, where said input/output device provides information concerning general park information, specific attraction information including news, updates, attraction description, wait times, various attraction packages available for purchase, or any other information concerning the park.

100. The method in accordance with claim 95, where said website provides information concerning general park information, specific attraction information including news, updates, attraction description, wait times, various attraction packages available for purchase, or other information concerning the park.

101. The method in accordance with claim 94, where said pre-sale attraction packages consists of reservations for 5 to 15 attractions, meal reservations, a parking pass, and an identification card that can be used like a credit card within the park and be taken home like a souvenir.

102. The method in accordance with claim 94, where purchased pre-sale attraction package data is then relayed to said maintenance unit.

103. The method in accordance with claim 94, where said pre-sale attraction package is determined by an algorithm that takes into account a number of variables including the time of year, current park attendance levels, the day of the week, the time of the month, the weather, the length of time to complete the attraction, the time it takes to walk from attraction to attraction, the time it takes for meals, the seating capacity of said attraction, forecasted attendance, and the popularity of said attraction.

104. The method in accordance with claim 94, where data from said purchased pre-sale attraction package is relayed back to said maintenance unit to be stored into a storage device.

105. The method in accordance with claim 94, where purchased pre-sale attraction package data is relayed to the appropriate controller unit.

106. The method in accordance with claim 94, where purchasers of said pre-sale attraction packages purchased via the World Wide Web/Internet or through the phone are mailed a guest card enabling the guest to access the parks systems.

107. The method in accordance with claim 94, where said controller unit stores the purchased attraction package into a data storage device.

108. The method in accordance with claim 94, where said parking lot is accessed through a blocking device linked to said controller unit designed to identify valid pre-sale attraction package holders with advanced parking purchases.

109. The method in accordance with claim 94, where said park is accessed through a barrier device linked to said controller unit designed to identify valid pre-sale attraction package holders.

110. The method in accordance with claim 94, where said attraction is accessed through two queues linked to said controller unit comprising:
a reservation queue for guests who have reserved a position or purchased a position in advance; and
a non-reservation queue for guests wishing to arrive at said attraction and wait for the next available seating.

111. The method in accordance with claim 94, where said maintenance unit works in conjunction with said controller to manage access to each attraction so as to fill each attraction to full capacity.

112. The method in accordance with claim 94, where said maintenance unit directs said controller unit to fill unclaimed reservation seats with guests waiting in said non-reservation queue.

113. The method in accordance with claim 94, where said controller unit directs a system of two queues by limiting access to a reservation queue to valid reservation holders and valid pre-sale attraction package purchasers and keeping track of the number of guests waiting in a non-reservation queue.

114. The method in accordance with claim 94, where said controller unit displays wait times for said non-reservation queue and the reservation times that remain available, advertisements, or other personal guest information.

115. The method in accordance with claim 110, where said reservation queue verifies valid reservation holders and valid pre-sale attraction package holders through the use of an identifying device.

116. The method in accordance with claim 115, where said identifying device identifies guests by accessing stored information of a guest through the use of a guest card containing an accessing device selected from the group consisting of a magnetic stripe, a microchip, or a bar code.

117. The method in accordance with claim 110, where said reservation queue limits entrance into said reservation queue valid reservation holders and valid pre-sale attraction package holders through the use of a barrier.

118. The method in accordance with claim 117, where said barrier allows entry only upon verification by said identifying device.

119. The method in accordance with claim 110, where said reservation queue limits entrance to said attraction until the attraction is available through the use of a second barrier.

120. The method in accordance with claim 110, where said non-reservation queue includes a counting device to count the number of guests entering said non-reservation queue.

121. The method in accordance with claim 110, where number of guests waiting in said non-reservation queue is relayed to said maintenance unit.

122. The method in accordance with claim 110, where said non-reservation queue wait times is determined through the use of an algorithm.

123. The method in accordance with claim 122, where said algorithm takes into account the length of time to complete the attraction, the seating capacity, and off times for the attraction to determine a wait time associated with said attraction.

124. The method of claim 110, where said non-reservation queue includes a second barrier to limit entrance into said attraction until the attraction is available.

125. A method of operating a park, comprising the steps of:
selling a pre-sale attraction package containing all the attractions prior to the guest's entrance to a park;
relaying sale information reporting the sale to a maintenance unit associated with the park;
relaying the sale information from the maintenance unit to a controller unit;
permitting entry into the park by the guest having a valid pre-sale attraction package.

126. The method of claim 125, wherein said pre-sale attraction package contains reservation times for every attraction in said park.

127. The method of claim 125, wherein said park only contains attraction which are accessible by pre-sale attraction package holders with pre-determined reservation times for all attractions.

128. A reservation system for scheduling admission of guests into attractions comprising:
an input/output device;
a reservation application linked to the input/output device to store, receive, send, and process data wherein a portion of said processed data is the scheduling of a limited number of active reservations.

129. The system of claim 128, where said reservation application is capable of performing multiple functions and calculations, receive and transmit data from guests, park employees, and other devices located within the park, store data, compute optimal reservation times, verify valid ticket holders, and control park functions.

130. A method of scheduling admission of guests into attractions comprising the steps of:
making a reservation at an input/output device;
relaying that request from the input/output device to a reservation application to be processed wherein a portion of said processed data is the scheduling and sale of a limited number of active reservations;
relaying the proposed schedule from said reservation application back to the input/output device to be accepted or rejected by the guest;
relaying the acceptance or rejection from the input/output device to the reservation application in order to be updated by the data files of the system.
